(19) United States
(12) Patent Application Publication
(10) Pub. No.: US 2016/0299037 A1
(43) Pub. Date: Oct. 13, 2016

(54) Automated Cut Scoring

(71) Applicant: Caterpillar Inc., Peoria, IL (US)

(72) Inventors: James H. DeVore, Metamora, IL (US); Michael A. Taylor, Swissvale, PA (US); Troy K. Becicka, Sahuarita, AZ (US)

(73) Assignee: Caterpillar Inc., Peoria, IL (US)

(21) Appl. No.: 14/680,290

(22) Filed: Apr. 7, 2015

(51) Int. Cl. G01M 17/03; G01L 5/00; G01L 3/24

(52) U.S. Cl. CPC G01M 17/03; G01L 3/24; G01L 5/0095

(57) ABSTRACT

A computer-implemented method of scoring an automated pass performed by a machine having an implement is provided. The computer-implemented method may include calculating a normalized power value based on one or more machine parameters, determining an average normalized power value based on the normalized power value calculated during the pass, and generating a status indicator based on the average normalized power value and one or more predefined thresholds.

### TECHNICAL FIELD

The present disclosure relates generally to autonomous and semi-autonomous machines, and more particularly, to methods, devices and systems for monitoring work progress and identifying suboptimal conditions.

### BACKGROUND

Machines such as track-type tractors, dozers, motor graders, wheel loaders, and the like, are used to perform a variety of tasks, including, for example, moving material and/or altering work surfaces at a worksite. In general, these machines may function in accordance with a work plan for a given worksite to perform operations, including digging, loosening, carrying, and any other manipulation of material within a worksite. Furthermore, the work plan may often involve repetitive tasks that may be entirely or at least partially automated to minimize operator involvement and promote efficiency. A given work environment may thus involve not only manned machines, but also autonomous or semi-autonomous machines that perform tasks in response to preprogrammed commands or commands delivered remotely and/or locally.

In automated work environments, it is especially desirable to ensure that the machines perform work operations in an efficient and productive manner in accordance with the given work plan. Seemingly minor deviations from the work plan, if undetected or left unaddressed, may be compounded into more significant and obvious errors in the eventual work product. Correspondingly, early detection of deviations in the work progress or suboptimal machine settings can play an important role in ensuring efficient and productive passes, such as by requesting earlier operator intervention and correction to compensate for the errors. However, in the context of automated work environments, remotely monitoring multiple groups of different machines with a limited number of operators can be challenging.

Some forms of monitoring for error states in vehicles are conventionally available. In one example, U.S. Pat. No. 8,612,091 (“Thompson”) discloses a vehicle diagnostic tool which uses parameter identification information extracted from a powertrain control module to help a technician in making diagnostic decisions. However, systems such as in Thompson, which are used for vehicle diagnostics, do not take environmental factors into consideration and do not gauge metrics of work productivity. Furthermore, such complex diagnostic systems can be burdensome for repeated and routine use, and not well-suited for remotely monitoring the productivity of a group of autonomous work machines operating within a work environment relative to a preprogrammed work plan.

Accordingly, there is a need for more simplified and yet reliable means for remotely monitoring autonomous and semi-autonomous work machines. Moreover, there is a need for assessment techniques which dynamically adapt to changing work environments and provide earlier detection of suboptimal conditions to improve productivity and efficiency. The present disclosure is directed at addressing one or more of the deficiencies and disadvantages set forth above. However, it should be appreciated that the solution of any particular problem is not a limitation on the scope of this disclosure or of the attached claims except to the extent express noted.

### SUMMARY OF THE DISCLOSURE

In one aspect of the present disclosure, a computer-implemented method of scoring an automated pass performed by a machine having an implement is provided. The method may include calculating a normalized power value based on one or more machine parameters, determining an average normalized power value based on the normalized power value calculated during the pass, and generating a status indicator based on the average normalized power value and one or more predefined thresholds.

In another aspect of the present disclosure, a control system for scoring an automated pass performed by a machine having an implement is provided. The control system may include a memory configured to retrievably store one or more algorithms, and a controller in communication with the memory and, based on the one or more algorithms. The controller may be configured to at least calculate a normalized power value based on one or more machine parameters, determine an average normalized power value based on the normalized power value calculated during the pass, and generate a status indicator based on the average normalized power value.

In yet another aspect of the present disclosure, a controller for scoring an automated pass performed by a machine having an implement is provided. The controller may include a normalization module configured to calculate a normalized power value based on one or more machine parameters, an averaging module configured to determine an average normalized power value based on the normalized power value calculated during the pass, and a status indicator module configured to generate a status indicator based on the average normalized power value and one or more predefined thresholds.

### BRIEF DESCRIPTION OF THE DRAWINGS

FIG. 1 is a pictorial illustration of one exemplary worksite within which the present disclosure may be implemented;

FIG. 2 is a diagrammatic illustration of one exemplary control system of the present disclosure;

FIG. 3 is a diagrammatic illustration of one exemplary controller of the present disclosure;

FIG. 4 is a graphical illustration of one exemplary operator interface of the present disclosure providing status indicators;

FIG. 5 is a diagrammatic illustration of a target cut profile and associated passes defined within a slot of within a worksite; and

FIG. 6 is a flowchart illustrating one exemplary method for scoring an automated pass.

### DETAILED DESCRIPTION

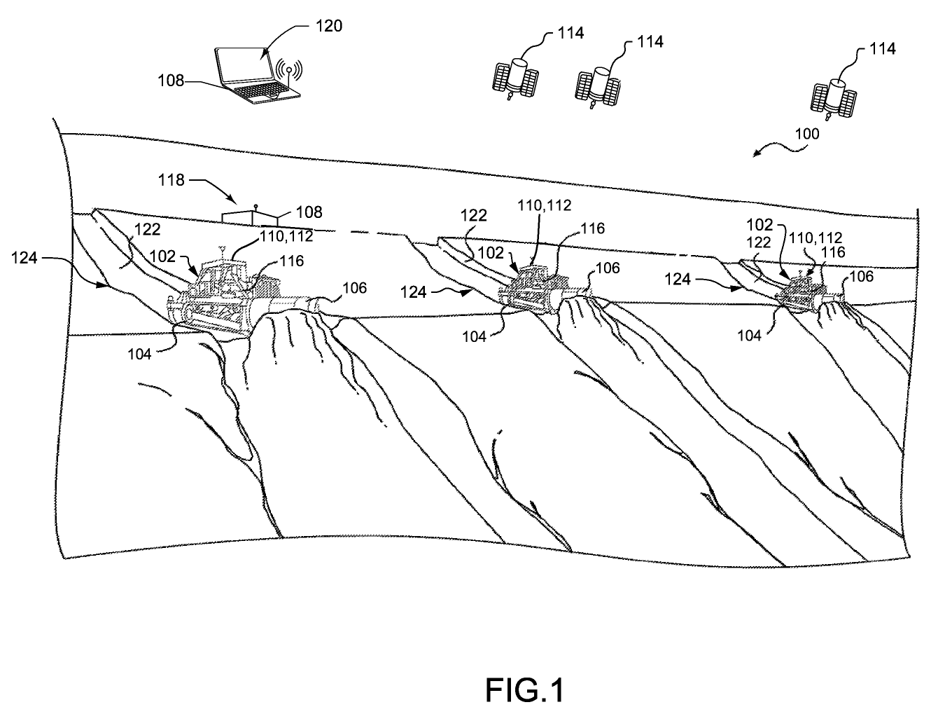

Referring now to FIG. 1, one exemplary worksite 100 is illustrated with one or more machines 102 performing predetermined tasks. The worksite 100 may include, for example, a mine site, a landfill, a quarry, a construction site, or any other type of worksite. The predetermined task may be associated with altering the geography at the worksite 100, such as a dozing operation, a grading operation, a leveling operation, a bulk material removal operation, or any other type of operation that results in geographical modifications within the worksite 100. The machines 102 may be mobile machines configured to perform operations associated with industries related to mining, construction, farming, or any other industry known in the art. The machines 102 depicted in FIG. 1, for example, may embody earth moving machines, such as dozers having fraction devices 104, such as tracks, wheels, or the like, as well as movable blades or other work implements 106. The machines 102 may also include manned machines or any type of autonomous or semi-autonomous machines.

The overall operations of the machines 102 and the machine implements 106 within the worksite 100 may be managed by a control system 108 that is at least partially in communication with the machines 102. Moreover, each of the machines 102 may include any one or more of a variety of feedback devices 110 capable of signaling, tracking, monitoring, or otherwise communicating relevant machine parameters or related information, such as machine slope, machine slip, productivity ratings, pass duration, pass distance, engine speed, engine load, fuel consumption rates, or the like, to the control system 108. Each machine 102 may also include, for example, a locating device 112 configured to communicate with one or more satellites 114, which in turn, may communicate to the control system 108 various information pertaining to the position and/or orientation of the machines 102 relative to the worksite 100. Each machine 102 may additionally include one or more implement sensors 116 configured to track and communicate position and/or orientation information of the implements 106 to the control system 108.

The control system 108 may be implemented in any number of different arrangements. For example, the control system 108 may be at least partially implemented at a command center 118 situated remotely and/or locally relative to the worksite 100 with sufficient means for communicating with the machines 102, for example, via satellites 114, or the like. Additionally or alternatively, the control system 108 may be implemented using one or more computing devices 120 with means for communicating with one or more of the machines 102 or one or more command centers 118 that may be remotely and/or locally situated relative to the worksite 100. In still further alternatives, the control system 108 may be implemented on-board any one or more of the machines 102 that are also provided within the worksite 100. Other suitable modes of implementing the control system 108 are possible and will be understood by those of ordinary skill in the art.

Using any of the foregoing arrangements, the control system 108 may generally be configured to monitor the positions of the machines 102 and/or implements 106 relative to the worksite 100 and a predetermined target operation, and provide instructions for controlling the machines 102 and/or implements 106 in an efficient manner in executing the target operation. In certain embodiments, the machines 102 may be configured to excavate areas of a worksite 100 according to one or more predefined excavation plans. The excavation plans can include, among other things, determining the location, size, and shape of a plurality of cuts into an intended work surface 122 at the worksite 100 along one or more slots 124. In such embodiments, the control system 108 may be used to plan not only the overall excavation, but also to define a pass, or an implement path within the slots 124 or any other areas of the work surface 122. For a given pass, for instance, the control system 108 may define a blade path, composed of a loading profile and a carry profile, suited to guide the machines 102 in an efficient, productive and predictable manner. Although described in connection with planned cut profiles and passes along a work surface 122, the control system 108 may similarly be employed in conjunction with other comparable types of tasks.

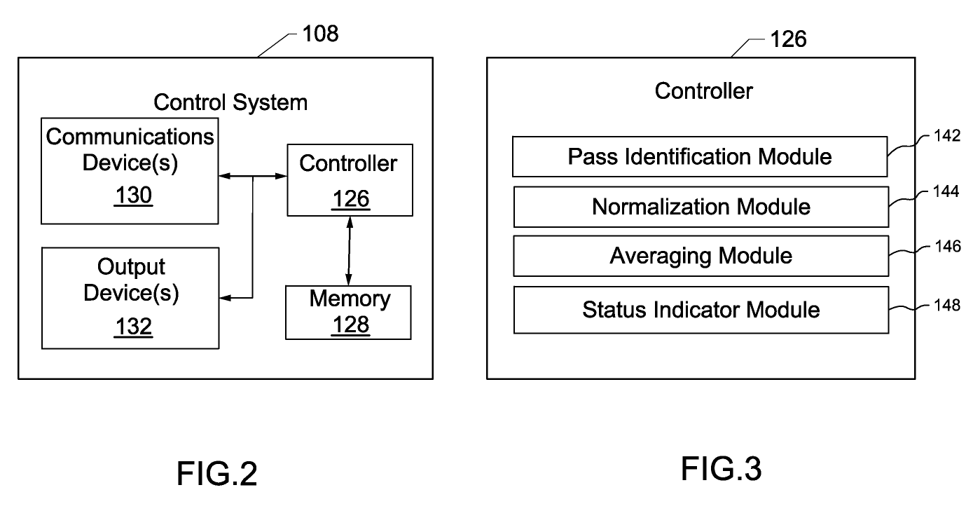

Turning to FIGS. 2 and 3, exemplary embodiments of a control system 108 and a controller 126 that may be used in conjunction with the worksite 100 and the machines 102 of FIG. 1 are diagrammatically provided. As shown in FIG. 2, the control system 108 may generally include the controller 126, a memory 128, a communications device 130, and one or more output devices 132, among other things. The controller 126 may be configured to operate according to one or more algorithms that are retrievably stored within the memory 128. The memory 128 may be provided on-board relative to the controller 126, external to the controller 126, or otherwise in communication therewith. Moreover, the controller 126 may be implemented using any one or more of a processor, a microprocessor, a microcontroller, or any other suitable means for executing instructions stored within the memory 128. Additionally, the memory 128 may include non-transitory computer-readable medium or memory, such as a disc drive, flash drive, optical memory, read-only memory (ROM), or the like.

The communications device 130 in FIG. 2 may be configured to enable the controller 126 to communicate with one or more of the machines 102, and receive information pertaining to the position and/or orientation of the machines 102 and the machine implements 106, for example, via satellites 114, or any other suitable means of communication. More specifically, the communications device 130 may track data pertaining to the operating conditions of one or more of the machines 102 which may be used to track changes to the work environment or worksite 100 as well as the overall work progress. For example, the communications device 130 may track machine parameters including any one or more of machine slope, machine slip, pass duration, pass distance, engine speed, fuel consumption rates, productivity ratings of the associated machine 102, and the like. In other embodiments, the communications device 130 may be configured to track any other parameter or operating condition related to the worksite 100, the machine 102, and/or the implement 106.

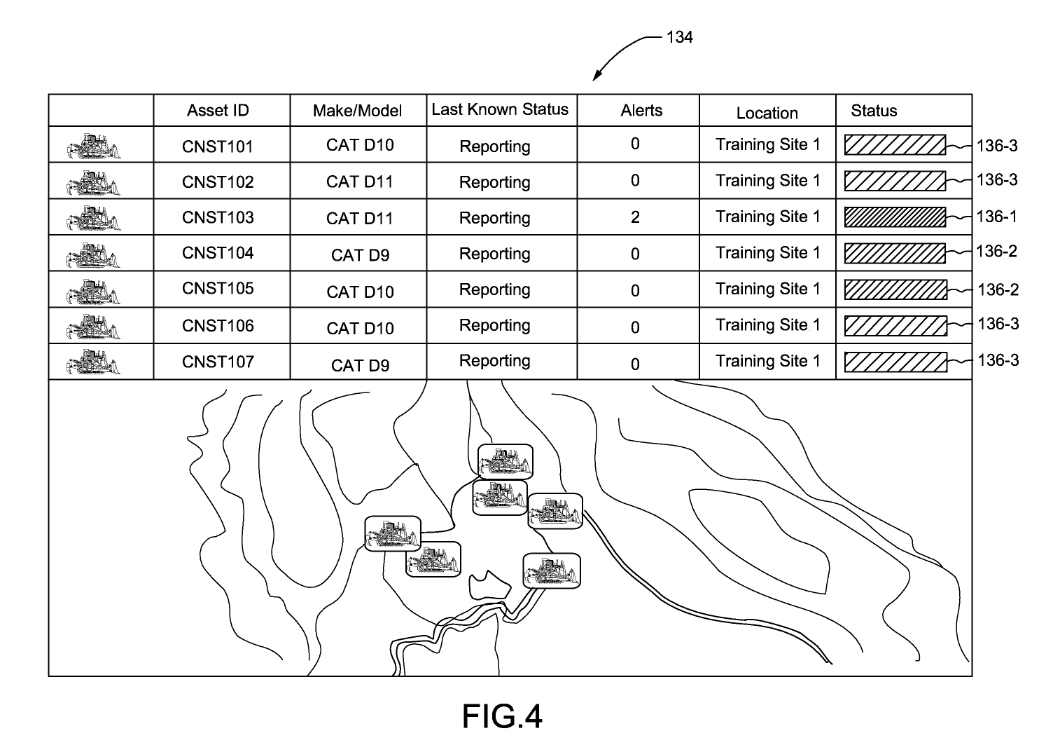

As further shown in FIG. 4, the output device 132 may be configured to output or, for example, present through an operator interface 134 one or more status indicators 136 corresponding to the progress of one or more of the machines 102 relative to the given work plan to an operator that is either remotely or locally situated from the worksite 100. The output device 132 may employ any combination of display screens, touchscreens, light-emitting diodes (LEDs), speakers, haptic devices, and the like, to provide visual, audible and/or haptic indications of the status of the work being performed. More particularly, the status indicators 136 may provide information corresponding to the operating conditions of the machine 102, the progress of the work or operation being performed, and any other indications of efficiency, productivity, errors, deviations, suboptimal operating conditions, and the like. Furthermore, the status indicators 136 may be provided using color-coded schemes as shown in FIG. 4 or any other visual cues that are easily noticeable and suited to promptly indicate work progress to an operator.

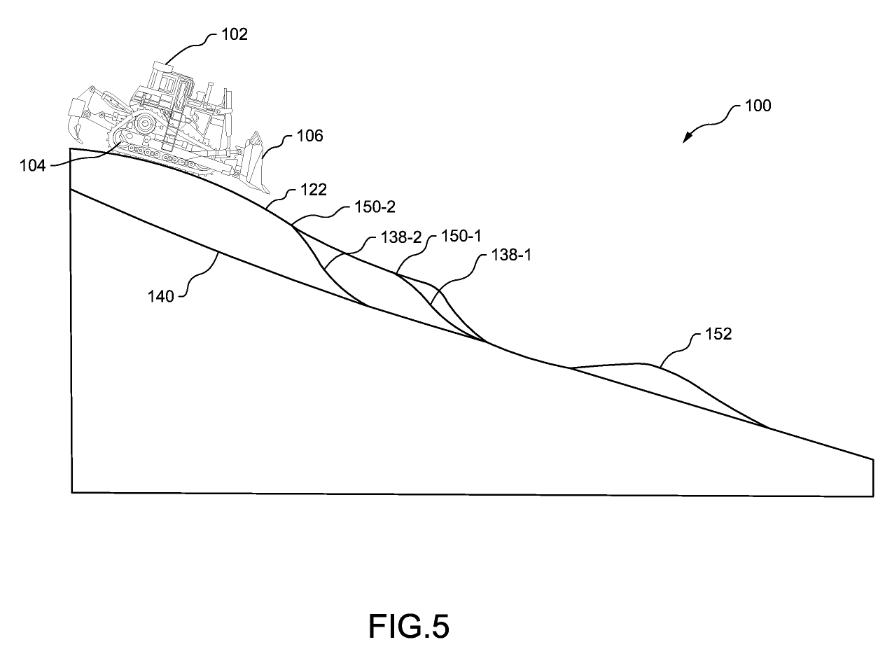

Referring back to FIG. 3, and with further reference to the diagram of FIG. 5, the controller 126 may be configured to periodically score or assess an automated cut or pass 138 that is performed along a planned cut profile 140, and enable operators remotely or locally monitoring the pass 138 to promptly respond or intervene as necessary. Specifically, the controller 126 may be configured to function according to one or more preprogrammed algorithms, which may be generally categorized into, for example, a pass identification module 142, a normalization module 144, an averaging module 146, and a status indicator module 148. Among other things, the pass identification module 142 may configure the controller 126 to at least spatially identify and define the pass 138 to be performed relative to the worksite 100. As shown in the dozing operation of FIG. 5, for instance, each pass 138 may be predefined as a generally repeatable cycle including the operations of engaging a cut at a first cut location 150-1, loading material into the implement 106 of the machine 102, carrying or dumping the loaded material over a crest 152 of the worksite 100, and returning the machine 102 to a subsequent or second cut location 150-2. Based on the desired application, each pass 138 or cycle may also be defined to include other combinations of operations.

Once the machine 102 begins performing the pass 138, the normalization module 144 of FIG. 3 may configure the controller 126 to begin calculating or otherwise determining a normalized power value associated with the machine 102 based on one or more machine parameters provided by, for example, the communications device 130. The machine parameters may include any one or more of machine slope, machine slip, pass duration, pass distance, engine speed, fuel consumption rates, productivity ratings of the associated machine 102, and the like. While the normalized power value may take any one of a number of different forms, in one embodiment, the normalized power value is calculated as a percentage or ratio of an applied power value to an optimum power value. The applied power value may be indicative of the actual power that is applied by the machine 102 while performing the pass 138. The optimum power value may be indicative of the maximum power that can be applied for the given ground conditions, or the amount of power that, if applied, would result in peak productivity for the specific pass 138, or for specific locations within the pass 138. Correspondingly, a normalized power value having a percentage of 100% or a ratio of 1 indicates that the machine 102 is operating at optimum or peak productivity levels for at least that pass 138 or particular instances or locations along the pass 138. In general, normalized power values substantially lower than 100% or 1 may indicate suboptimal productivity due to an underpowered machine 102, or an overpowered machine 102 that is exhibiting higher rates of wheel or track slip, or the like.

In this manner, the normalization module 144 may configure the controller 126 to continue calculating the normalized power value for the duration of the given pass 138-1 and any subsequent passes 138-2, such as at predefined intervals of time, distance, or any other designations. Moreover, while the normalization module 144 calculates the normalized power value, the averaging module 146 may configure the controller 126 to determine an average normalized power value for the pass 138. For example, the averaging module 146 may calculate and update the average normalized power value, as the average of the calculated normalized power values for that pass 138. In one embodiment, the averaging module 146 may determine and update the average normalized power value once per pass 138 or cycle. In other embodiments, the averaging module 146 may determine and update the average normalized power value multiple times per pass 138 or cycle, for example, for every normalized power value that is calculated by the normalization module 144 for duration of the pass 138.

Furthermore, the status indicator module 148 of FIG. 3 may configure the controller 126 to generate or update a status indicator 136 corresponding to a productivity rating of the machine 102 for the pass 138. Specifically, the status indicator module 148 may configure the controller 126 to first qualify the average normalization power value determined by the averaging module 146 based on a comparison with one or more predefined thresholds. As shown for example in FIG. 4, the status indicator module 148 may selectively generate one of a critical status indicator 136-1, a cautionary status indicator 136-2, and a normal status indicator 136-3. The critical status indicator 136-1 may be generated when the average normalized power value is less than a first or lower minimum threshold, while the cautionary status indicator 136-2 may be generated when the average normalized power value is greater than the lower minimum threshold but less than a second or higher minimum threshold. The normal status indicator 136-3 may be enabled when the average normalized power value is greater than both of the first and second minimum thresholds. Moreover, the status indicator module 148 may update the status indicator 136 for each consecutive average normalized power value that is calculated.

The status indicator module 148 of FIG. 3 may configure the controller 126 to communicate each status indicator 136 to one or more operators remotely and/or locally situated relative to the machine 102 and/or worksite 100. For example, the status indicators 136 may be communicated by the communications device 130 to the operators via one or more operator interfaces 134 provided through one or more local or remote output devices 132. In one embodiment, the status indicators 136 may be presented using a color-coded scheme. As shown for example in FIG. 4, a critical status indicator 136-1 may be presented in red on the operator interface 134 to indicate that the machine 102 has a poor productivity rating and that operator intervention may be necessary. A cautionary status indicator 136-2 may be presented in yellow on the operator interface 134 to indicate that the machine 102 is operating at a suboptimal but acceptable productivity rating, and to serve as a warning that operator intervention may be necessary. Correspondingly, a normal status indicator 136-3 may be presented in green on the operator interface 134 to indicate to the operator that the machine 102 is operating at an optimum productivity rating and that no intervention is necessary.

In other embodiments, the status indicator module 148 may be configured with fewer or more thresholds to provide for fewer or more categories of status indicators 136. In alternative embodiments, one or more of the thresholds may be manually modified by the operators such as by using the operator interface 134, and/or automatically adjusted based on detected changes in the machine 102, worksite 100, or other factors. In other modifications, the status indicators 136 may be provided using different color-coded schemes or any other visual cues that are easily noticeable and suited to promptly indicate suboptimal conditions to an operator. In other alternatives, the different types of status indicators 136 may be provided using audible and/or haptic schemes. In still further modifications, the operator interface 134 may also provide additional information, instructions and/or suggestions relating to each status indicator 136 which may guide the operator in correcting any deficiencies detected during the pass 138.

Each of the normalization module 144, averaging module 146, and the status indicator module 148 may continue updating the calculated normalized power value, the average normalized power value, and the status indicator 136 for each pass 138 or at predefined intervals of time, distance, or other designations within each pass 138. Once the given pass 138-1 is complete, and if the pass identification module 142 identifies subsequent passes 138-2 to be performed, the controller 126 may generally repeat the above processes for each subsequent pass 138-2 until the entire slot 124 is complete. More specifically, at the start of the new pass 138-2 or cycle, the averaging module 146 may apply the average normalized power value determined from the previous pass 138-1 as the new starting average normalized power value from which the new pass 138-2 will be assessed. Upon the start of the new pass 138-2 or cycle, the normalization module 144 may also reset calculations to adjust for any changes in the machine parameters, work environment, or other factors since the previously performed pass 138-1.

Other variations and modifications to the algorithms or methods will be apparent to those of ordinary skill in the art. Exemplary algorithms or methods by which the controller 126 may be operated to monitor work progress and assess the productivity of automated passes or cycles is discussed in more detail below.

### INDUSTRIAL APPLICABILITY

In general, the present disclosure sets forth methods, devices and systems for monitoring and scoring automated passes performed by a machine, where there are motivations to improve overall efficiency and productivity. Although applicable to any type of machine, the present disclosure may be particularly applicable to autonomously or semi-autonomously controlled dozing machines where the dozing machines are controlled along particular travel routes within a worksite to excavate materials. Moreover, the present disclosure simplifies the assessment of work productivity by determining a score based on the average normalized power value assessed for given passes. Furthermore, by periodically updating the score per pass or work cycle, the present disclosure enables earlier detection and flagging of suboptimal operating conditions or seemingly insignificant deviations from the work plan which may potentially impact overall productivity. Additionally, by enabling earlier flagging of potentially adverse impacts to productivity, the present disclosure provides operators remotely and/or locally monitoring one or more machines with more time and earlier opportunities to promptly intervene and correct any flagged deficiencies.

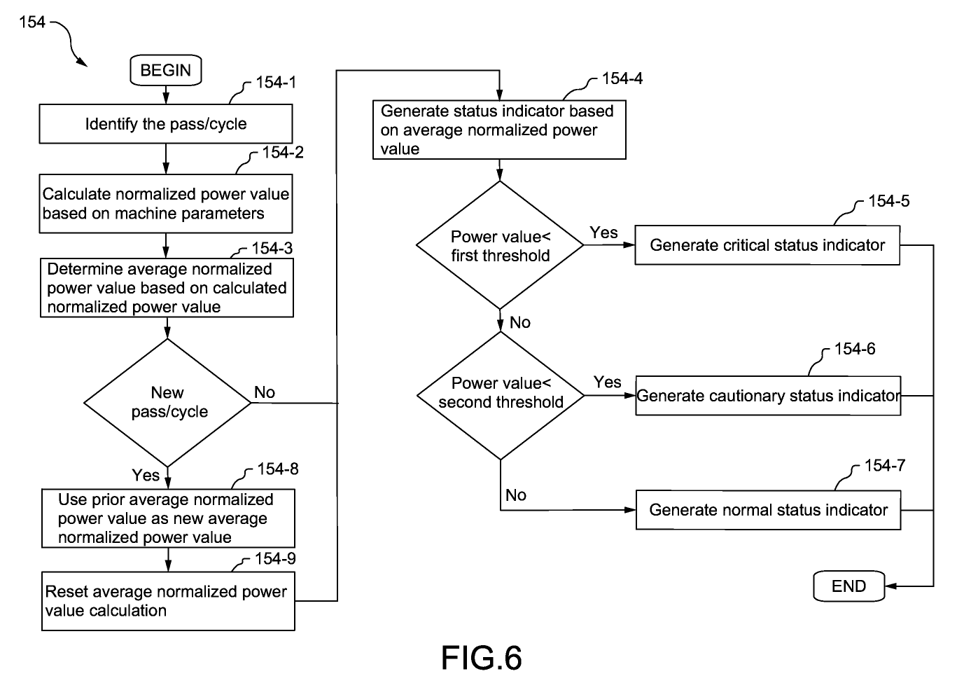

Turning to FIG. 6, one exemplary algorithm or computer-implemented method 154 for scoring an automated pass 138 performed by a machine 102 having an implement 106 is diagrammatically provided, according to which the control system 108 and the controller 126 may be configured to operate. As shown in block 154-1 of FIG. 6, and as described with respect to the pass identification module 142 of FIG. 3, the controller 126 may spatially identify or define the pass 138 to be performed relative to the worksite 100. For example, the controller 126 may define each pass 138 as a generally repeatable cycle including the operations of engaging a cut at a first cut location 150-1, loading material into the implement 106 of the machine 102, carrying or dumping the loaded material over a crest 152 of the worksite 100, and returning the machine 102 to a subsequent or second cut location 150-2. Based on the desired application, the controller 126 may also define each pass 138 or cycle to include other combinations of operations. Once the pass 138 has been sufficiently identified, the controller 126 may engage the machine 102 to begin performing the pass 138.

While the machine 102 performs the pass 138, the controller 126 in block 154-2 of FIG. 6, and as described with respect to the normalization module 144 of FIG. 3, may calculate a normalized power value for the machine 102 and the given pass 138 based on one or more machine parameters. The machine parameters may include any one or more of machine slope, machine slip, pass duration, pass distance, engine speed, fuel consumption rates, productivity ratings of the associated machine 102, and the like. Furthermore, the controller 126 may calculate the normalized power value as a ratio of an applied power value to an optimum power value. The applied power value may be indicative of the actual power that is applied by the machine 102 while performing the pass 138. The optimum power value may be indicative of the maximum power that can be applied for the given ground conditions, or the amount of power that, if applied, would result in peak productivity for the specific pass 138, or for specific locations within the pass 138. For example, a normalized power value having a ratio of 1 may indicate that the machine 102 is operating at optimum or peak productivity levels for the pass 138 or particular instances or locations within the pass 138, and normalized power values having ratios lower than 1 may indicate suboptimal productivity.

The controller 126 in 154-2 may continue calculating the normalized power value for the pass 138 at predefined intervals of time, distance, or any other designations. In block 154-3 of FIG. 6, and as described with respect to the averaging module 146 of FIG. 3, the controller 126 may additionally determine or calculate an average normalized power value for the pass 138. For each normalized power value that is calculated, for example, the controller 126 may calculate and update the average normalized power value, or the average of the calculated normalized power values for the given pass 138. In one embodiment, the controller 126 may determine and update the average normalized power value once per pass 138 or cycle. In other embodiments, the controller 126 may determine and update the average normalized power value multiple times per pass 138 or cycle, for example, for every normalized power value that is calculated for duration of the pass 138. Correspondingly, the controller 126 may additionally monitor progress of the machine 102 and the pass 138 to determine whether the machine 102 is still progressing along the given pass 138-1, or whether the machine 102 has completed the initial pass 138-1 and is starting a new pass 138-2.

If the machine 102 is determined to be continuing along the initial pass 138-1, the controller 126 in block 154-4 of FIG. 6, and as discussed with respect to the status indicator module 148 of FIG. 3, may generate one or more status indicators 136 based on the average normalized power value previously determined and one or more predefined thresholds. As shown in the operator interface 134 of FIG. 4 for example, if the average normalized power value falls below a first or lower minimum threshold, the controller 126 in block 154-5 may generate a critical status indicator 136-1 in red to indicate low productivity and to suggest to an operator that at least some manual intervention or correction of the machine 102 may be needed to restore acceptable productivity levels. If the average normalized power value satisfies the first or lower minimum threshold, but falls below a second or higher minimum threshold, the controller 126 in block 154-6 may generate a cautionary status indicator 136-2 in yellow to indicate suboptimal but acceptable productivity and to warn the operator of potentially adverse deviations from the planned operation. If the average normalized power value satisfies both of the first and second minimum thresholds, the controller 126 in block 154-7 may generate a normal status indicator 136-3 in green to indicate optimum productivity to the operator.

The controller 126 may continue updating the calculated normalized power value, the average normalized power value, and the corresponding status indicator 136 in this manner for each pass 138 performed, or at predefined intervals of time, distance, or other designations within each pass 138 performed. If a new pass 138-2 or cycle is detected, the controller 126 in block 154-8, and as described with respect to the averaging module 146 of FIG. 3, may use the average normalized power value previously determined for the prior pass 138-1 toward the new pass 138-2. For example, at the start of the new pass 138-2 or cycle, the controller 126 may apply the average normalized power value determined for the previous pass 138-1 as the new starting average normalized power value from which the new pass 138-2 can be assessed. Upon starting the new pass 138-2 or cycle, the controller 126 according to block 154-9 of FIG. 6, and as also described with respect to the averaging module 146, may additionally reset calculations to adjust for any detected changes in the machine parameters, work environment, or other factors since the previous pass 138-1. Furthermore, once all updates have been made, the controller 126 may proceed to block 154-4 to generate the appropriate status indicators 136 as discussed above.

From the foregoing, it will be appreciated that while only certain embodiments have been set forth for the purposes of illustration, alternatives and modifications will be apparent from the above description to those skilled in the art. These and other alternatives are considered equivalents and within the spirit and scope of this disclosure and the appended claims.

What is claimed is:

1. A computer-implemented method of scoring an automated pass performed by a machine having an implement, comprising:
calculating a normalized power value based on one or more machine parameters;
determining an average normalized power value based on the normalized power value calculated during the pass; and
generating a status indicator based on the average normalized power value and one or more predefined thresholds.

2. The computer-implemented method of claim 1, wherein the machine parameters includes one or more of a machine slope, a machine slip, a productivity rating, a pass duration, a pass distance, an engine speed, an engine load, and a fuel consumption rate.

3. The computer-implemented method of claim 1, wherein the normalized power value is calculated as a ratio of an applied power value to an optimum power value, the optimum power value being indicative of peak productivity.

4. The computer-implemented method of claim 1, wherein the normalized power value is calculated at predefined intervals during the pass, each of the average normalized power value and the status indicator being updated at each interval and per calculation of the normalized power value.

5. The computer-implemented method of claim 1, wherein the pass includes a cycle of loading material into the implement, carrying the loaded material over a crest, and returning the machine to a subsequent cut location, the average normalized power value determined from a prior cycle being used as the average normalized power value for a subsequent cycle.

6. The computer-implemented method of claim 1, wherein the status indicator is generated as one of a critical status indicator, a cautionary status indicator, and a normal status indicator, the critical status indicator being generated when the average normalized power value is less than a first threshold, the cautionary status indicator being generated when the average normalized power value is greater than the first threshold but less than a second threshold, and the normal status indicator being generated when the average normalized power value is greater than both of the first threshold and the second threshold.

7. The computer-implemented method of claim 1, wherein the status indicator is communicated to an operator using an operator interface provided via one or more output devices of one or more control systems.

8. A control system for scoring an automated pass performed by a machine having an implement, comprising:
a memory configured to retrievably store one or more algorithms; and
a controller in communication with the memory and, based on the one or more algorithms, configured to at least:
calculate a normalized power value based on one or more machine parameters,
determine an average normalized power value based on the normalized power value calculated during the pass, and
generate a status indicator based on the average normalized power value.

9. The control system of claim 8, wherein the controller is configured to calculate the normalized power value based on one or more of a machine slope, a machine slip, a productivity rating, a pass duration, a pass distance, an engine speed, an engine load, and a fuel consumption rate.

10. The control system of claim 8, wherein the controller is configured to calculate the normalized power value as a ratio of an applied power value to an optimum power value that is indicative of peak productivity, and generate the status indicator based on a comparison of the average normalized power value and one or more predefined thresholds.

11. The control system of claim 8, wherein the controller is configured to calculate the normalized power value at predefined intervals during the pass, and update each of the average normalized power value and the status indicator at each interval and per calculation normalized power value.

12. The control system of claim 8, wherein the controller is configured to define the pass to include a cycle of loading material into the implement, carrying the loaded material over a crest, and returning the machine to a subsequent cut location, the controller being configured to apply the average normalized power value determined from a prior cycle as the average normalized power value for a subsequent cycle.

13. The control system of claim 8, wherein the controller is configured to generate the status indicator as one of a critical status indicator, a cautionary status indicator, and a normal status indicator, the controller being configured to generate the critical status indicator when the average normalized power value is less than a first threshold, generate the cautionary status indicator when the average normalized power value is greater than the first threshold but less than a second threshold, and generate the normal status indicator when the average normalized power value is greater than both of the first threshold and the second threshold.

14. The control system of claim 8, wherein the controller is configured to communicate the status indicator to an operator using an operator interface provided via one or more output devices in communication therewith.

15. A controller for scoring an automated pass performed by a machine having an implement, comprising:
a normalization module configured to calculate a normalized power value based on one or more machine parameters;
an averaging module configured to determine an average normalized power value based on the normalized power value calculated during the pass; and
a status indicator module configured to generate a status indicator based on the average normalized power value and one or more predefined thresholds.

16. The controller of claim 15, wherein the normalization module is configured to calculate the normalized power value based on one or more of a machine slope, a machine slip, a productivity rating, a pass duration, a pass distance, an engine speed, an engine load, and a fuel consumption rate.

17. The controller of claim 15, wherein the normalization module is configured to calculate the normalized power value as a ratio of an applied power value to an optimum power value that is indicative of peak productivity.

18. The controller of claim 15, further comprising a pass identification module configured to define the pass to include loading material into the implement, carrying the loaded material over a crest, and returning the machine to a subsequent cut location, the averaging module being configured to apply the average normalized power value determined from a prior cycle as the average normalized power value for a subsequent cycle.

19. The controller of claim 15, wherein the status indicator module is configured to generate the status indicator as one of a critical status indicator, a cautionary status indicator, and a normal status indicator, the status indicator module being configured to generate the critical status indicator when the average normalization power value is less than a first threshold, generate the cautionary status indicator when the average normalization power value is greater than the first threshold but less than a second threshold, and generate the normal status indicator when the average normalization power value is greater than both of the first threshold and the second threshold.

20. The controller of claim 15, wherein the status indicator module is configured to communicate the status indicator to an operator using an operator interface provided via one or more output devices in communication therewith.
